(19) United States
(12) Patent Application Publication
(10) Pub. No.: US 2005/0113125 A1
(43) Pub. Date: May 26, 2005

(54) Mobile communication terminal and method of using the same

(76) Inventor: Wan-Gyu Kang, Dongan-gu (KR)

Correspondence Address: MORGAN & FINNEGAN, L.L.P., 3 World Financial Center, New York, NY, 10281-2101, US

(21) Appl. No.: 10/949,424

(22) Filed: Sep. 24, 2004

(30) Foreign Application Priority Data
Sep. 25, 2003 (KR) 2003-66645

(51) Int. Cl. H04B 7/00

(52) U.S. Cl. 455/522; 455/562.1

(57) ABSTRACT

A mobile communication terminal having an antenna and method of using the same is disclosed in which the angle of the antenna is adjusted according to a Specific Absorption Rate (SAR) value of the mobile communication terminal and a user is notified when the SAR value exceeds a predetermined value. The method stores a plurality of SAR values each corresponding to a transmission power of the mobile communication terminal in a memory and determines a current transmission power of the mobile communication terminal in a call state. The method then reads a SAR value which corresponds to the current transmission power from the memory. The angle of the antenna is then adjusted according to the SAR value.

### BACKGROUND OF THE INVENTION

1. Field of the Invention

The present invention relates generally to a method of reducing the harmful influence of electromagnetic waves during the use of a mobile communication terminal and, more particularly, to a method of adjusting the angle of an antenna according to a specific absorption rate value in a mobile communication terminal and a method of notifying a user of the specific absorption rate value.

2. Description of the Related Art

A Specific Absorption Rate (SAR) is a numerical value that indicates how much a human body absorbs electromagnetic waves radiated from a mobile communication terminal. That is, the SAR is electromagnetic power that is absorbed by the human body per unit mass of the human body. Since a high SAR may be harmful to the human body, many countries prohibit the SAR for the head from exceeding certain values. For example, the SAR limit in both Korea and U.S.A. is 1.6 W/kg, while the SAR limit in both Europe and Japan is 2.0 W/kg.

While attempts have been made to reduce the harmful influence of electromagnetic waves on the human body by limiting a SAR level, the influence of electromagnetic waves on the human body may vary according to the user's usage or habits. Furthermore, the SAR may vary according to the radio wave environment.

One of the conventional techniques of reducing the influence of electromagnetic waves is the use of an electromagnetic wave blocking casing for a mobile communication terminal, which is fabricated of conductive material in various designs, thereby providing an electromagnetic wave blocking effect. The electromagnetic wave blocking casing may provide a mobile communication terminal with positive effects on ElectroMagnetic Interference (EMI) and ElectroMagnetic Susceptibility (EMS), but does not reduce the influence of electromagnetic waves radiated from the antenna of the mobile communication terminal. Theoretically, the application of the electromagnetic wave blocking material to a mobile communication terminal is problematic because electromagnetic waves are re-reflected by the electromagnetic wave blocking material and, therefore, the degree to which electromagnetic waves are absorbed into the human body is increased.

Another technology for reducing the absorption of electromagnetic waves into the human body provides a structure in which an antenna is mounted not on the top of a mobile communication terminal but on the bottom of the mobile communication terminal, so that the antenna can be placed away from the head, thus reducing the influence of the electromagnetic waves on the human body. Such a structure is advantageous in that the characteristics of the antenna are not influenced by the change in the location of the antenna and the degree of absorption of electromagnetic waves is reduced. However, the mobile communication terminal structure having an antenna on the bottom of the terminal is disadvantageous in that the positioning of the antenna at the bottom of the mobile communication terminal may be fatal to people using pacemakers and users may feel inconvenience because the location of the antenna is different from that of the conventional antenna.

Furthermore, attachments using various electromagnetic wave blocking or absorbing materials have been proposed to reduce the harmful influence of electromagnetic waves of a mobile communication terminal. The reducing effects of the electromagnetic wave of such attachments varies depending on the blocking/absorbing materials. In the case of electromagnetic wave blocking materials, the rate at which the human body absorbs electromagnetic waves is increased. In the case of electromagnetic wave absorbing materials, the rate at which the human body absorbs electromagnetic waves can be reduced by approximately 10˜20%. The attachments using the electromagnetic wave absorbing materials function as accessories, but may not be a fundamental solution to the harmful influence of electromagnetic waves.

### SUMMARY OF THE INVENTION

Accordingly, the present invention has been made keeping in mind the above problems occurring in the prior art, and an object of the present invention is to provide a method of storing an SAR value corresponding to transmission power and adjusting the angle of an antenna according to the SAR value in a mobile communication terminal so as to reduce the harmful influence of electromagnetic waves by moving the antenna away from the human body.

Another object of the present invention is to provide a method of displaying the SAR value to a user.

In order to accomplish the above object, the present invention provides a method of adjusting the angle of an antenna according to an SAR value in a mobile communication terminal and a method of notifying a user of the SAR value.

In the present invention, the angles of the antenna corresponding to SAR values are previously stored in memory. The SAR value corresponding to current transmission power is read from memory, and the angle of the antenna is adjusted according to the SAR value or an alarm sound is issued if the SAR value exceeds the predetermined reference value. If a call terminates, the antenna is preferably returned to its original position.

The angles of the antenna corresponding to SAR values may be previously stored in the memory, and the angle of the antenna may be adjusted according to the SAR value during a call. It is determined whether the SAR value is higher than a predetermined reference value, the angle of the antenna is reduced if the SAR value is higher than a predetermined reference value, and the antenna is returned to its original position if the SAR value is equal to or lower than the predetermined reference value.

If the SAR value exceeds the predetermined reference value, the SAR value can be displayed on the screen of the mobile communication terminal.

Other and further aspect of the present invention will become apparent during the course of the following detailed description and by reference to the attached drawings.

### BRIEF DESCRIPTION OF THE DRAWINGS

FIG. 1 is a block diagram showing the construction of a mobile communication terminal according to a preferred embodiment of the present invention;

FIG. 2 is a flowchart showing a method of adjusting the angle of the antenna of the mobile communication terminal according to a preferred embodiment of the present invention; and

FIG. 3 is a flowchart showing a method of indicating an a SAR value to the user according to a preferred embodiment of the present invention.

### DESCRIPTION OF THE PREFERRED EMBODIMENTS

Reference now should be made to the drawings, in which the same reference numerals are used throughout the different drawings to designate the same or similar components.

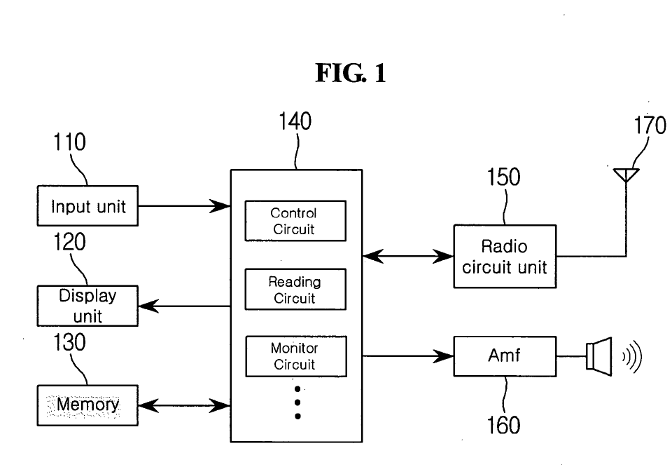

FIG. 1 is a block diagram showing the construction of a mobile communication terminal according to an embodiment of the present invention. The mobile communication terminal includes an input unit 110, a display unit 120, memory 130, a control unit 140, a radio circuit unit 150, an amplifier 160 and an antenna 170.

Various devices, such as a keypad, a jog shuttle, a point stick and a touch screen, may be used as the input unit 110. The input unit 110 is utilized when the user selects a desired function or inputs information.

The display unit 120 is utilized to show various information to the user. A Liquid Crystal Display (LCD) may be used as the display unit 120. In an embodiment of the present invention, a SAR value may be displayed on the display unit 120.

The memory 130 stores programs and data that are required for the operation of the mobile communication terminal. Erasable Programmable Read Only Memory (EPROM), Static Random Access Memory (SRAM) and flash memory may be used as the memory 130. SAR values proportional to the transmission powers of the mobile communication terminal may be stored in the memory 130. In an embodiment, the angle values of the antenna 170 corresponding to SAR values may be stored in the memory 130.

The control unit 140 functions to control the entire operation of the mobile communication terminal. The control unit 140 may be constructed using a microprocessor or a Digital Signal Processor (DSP). In an embodiment of the present invention, a SAR value corresponding to the transmission power of the mobile communication terminal is read from the memory 130, and the angle of the antenna 170 is adjusted according to the SAR value of the transmission power. The SAR value may also be displayed through the display unit 120, or an alarm sound may be issued through the amplifier 160.

The radio circuit unit 150 is used to allow the mobile communication terminal to wirelessly exchange data and control information with a base station. The radio circuit unit 150 functions to receive a call signal initiated by a calling party of another mobile communication terminal, through the antenna 170 and transmit the call signal to the control unit 140, or to transmit data stored in the memory 130 to a calling partner's mobile communication terminal through the antenna 170.

The amplifier 160 outputs a sound signal through a speaker connected therewith. For example, an alarm sound may be issued depending on a SAR value.

In an embodiment, the angle of the antenna 170 may be adjusted by a driving means such as a motor.

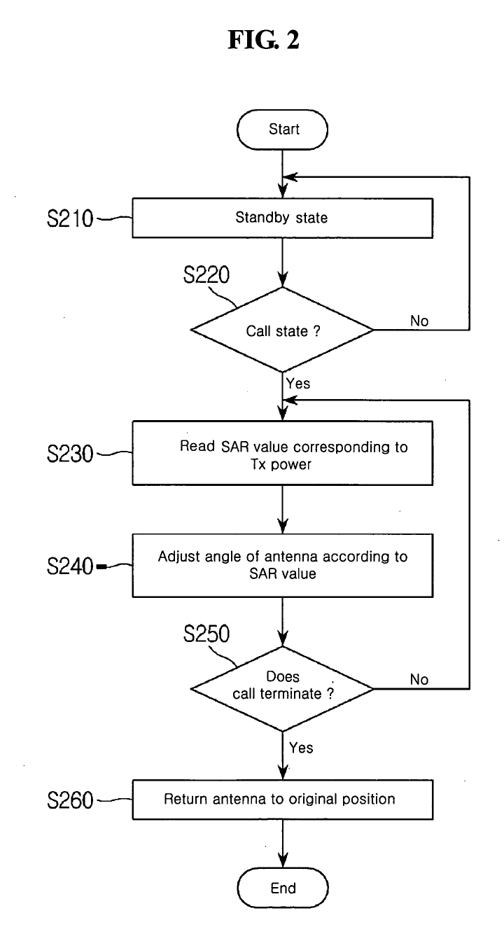

FIG. 2 is a flowchart showing a method of adjusting the angle of the antenna of the mobile communication terminal according to an embodiment of the present invention.

If a call signal is received or the user transmits a call signal in a standby state, the mobile communication terminal is switched to a call state, while if not, the mobile communication terminal stays in the standby state at steps S210 and S220.

If the mobile communication terminal is in a call state, a reading circuit of the control unit 140 reads the SAR value from the memory 130 at step S230 which corresponds to the transmission power of the mobile communication terminal determined by a monitor circuit of the control unit 140.

A control circuit of the control unit 140 adjusts the angle of the antenna 170 according to the SAR value at step S240. The adjustment of the angle of the antenna 170 may be performed by previously storing the angles of the antenna 170 corresponding to SAR values in the memory 130 and automatically adjusting the angle of the antenna 170 corresponding to the SAR value during communication. A predetermined angular value of the antenna 170 corresponding to the SAR value may be read first from the memory for the adjusting.

Alternatively, the adjustment of the angle of the antenna 170 may be performed by determining whether the SAR value is higher than a predetermined reference value, and reducing the angle of the antenna 170 if the SAR value is higher than the reference value and then returning the antenna 170 to its original position if the SAR value becomes equal to or lower than the reference value.

If the SAR value changes in the call state, the angle of the antenna 170 is adjusted according to the SAR value at step S240. If it is determined that a call terminates at step S250, the antenna 170 is returned to its original position at step S260.

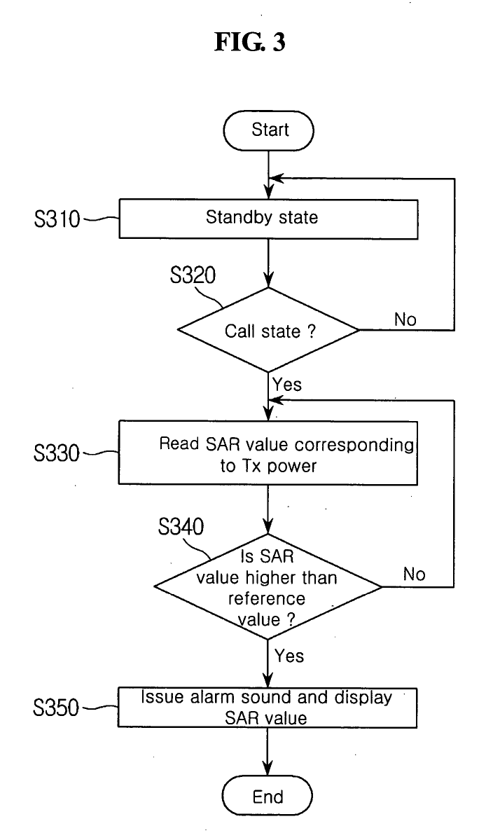

FIG. 3 is a flowchart showing a method of indicating an SAR value to the user in accordance with an embodiment of the present invention.

If a call signal is received or the user transmits a call signal in a standby state, the mobile communication terminal is switched to a call state, while if not, the mobile communication terminal stays in the standby state at steps S310 and S320.

If the mobile communication terminal is in a call state, the control unit 140 reads the SAR value corresponding to transmission power from the memory 130 at step S330.

At this time, if the SAR value is higher than a predetermined reference value, the control unit 140 issues an alarm sound through the amplifier 160. Additionally, the control unit 140 may issue a command to display the SAR value on the display unit 120. If not, the control unit 140 continuously reads the SAR value corresponding to transmission power, and determines whether the SAR exceeds the reference value at steps S340 and S350.

As described above, when an SAR value is higher than a predetermined value, the antenna is made to move away from the human body by adjusting the angle of the antenna of a mobile communication terminal, so that the influence of electromagnetic waves can be reduced. An alarm sound may also be issued, so that the user may avoid using the mobile communication terminal under the higher SAR value situation. The user then may use earphones or a speakerphone, thus reducing the influence of electromagnetic waves.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of adjusting angle of an antenna according to Specific Absorption Rate (SAR) values in a mobile communication terminal, comprising steps of:
storing a plurality of SAR values each corresponding to a transmission power of the mobile communication terminal in a memory;
determining a current transmission power of the mobile communication terminal in a call state;
reading a SAR value which corresponds to the current transmission power from the memory;
adjusting the angle of the antenna according to the SAR value read in the readng step.

2. The method as set forth in claim 1, further comprising the step of returning the antenna to its original position if the call state terminates.

3. The method as set forth in claim 1, wherein the step of adjusting further comprises the steps of:
reading a predetermined angular value of the antenna corresponding to the SAR value from the memory; and
adjusting the angle of the antenna according to the predetermined angular value of the antenna.

4. The method as set forth in claim 1, wherein the step of adjusting further comprises the steps of:
reducing the angle of the antenna if the SAR value is higher than a predetermined reference value; and
returning the antenna to its original position if the SAR value is equal to or lower than the predetermined reference value.

5. The method as set forth in claim 4, further comprising the step of issuing an alarm sound if the SAR value exceeds the predetermined reference value.

6. A method of notifying a user of SAR values in a mobile communication terminal, comprising steps of:
storing a plurality of SAR values each corresponding to a transmission power of the mobile communication terminal in a memory;
reading a SAR value corresponding to a current transmission power of the mobile communication terminal from the memory if the mobile communication terminal is in a call processing state;
issuing an alarm sound if the SAR value from the reading step exceeds a predetermined reference value.

7. The method as set forth in claim 6, wherein the step of issuing further comprises the step of displaying the SAR value if the SAR value exceeds the predetermined reference value.

8. A mobile communication terminal having an antenna comprising:
a memory configured to store a plurality of SAR values each corresponding to a transmission power of the mobile communication terminal;
a monitor circuit configured to determine a current transmission power of the mobile communication terminal in a call state;
a reading circuit configured to read from the memory a SAR value which corresponds to the current transmission power of the mobile communication terminal; and
a control circuit configured to adjust the angle of the antenna according to the SAR value read by the reading circuit.

9. The mobile communication termina of claim 8, wherein the control circuit is further configured to reduce the angle of the antenna if the SAR value is higher than a predetermined reference value.

10. The mobile communication terminal of claim 8, wherein the control circuit is further configured to return the antenna to its origina position if the SAR value is equal to or lower than a predetermined reference value.
